(19) United States
(12) Patent Application Publication
(10) Pub. No.: US 2021/0078813 A1
(43) Pub. Date: Mar. 18, 2021

(54) RECORDING MEDIUM DETECTION DEVICE AND IMAGE FORMING APPARATUS

(71) Applicant: Konica Minolta, Inc., Tokyo (JP)

(72) Inventors: Yumiko Izumiya, Tokyo (JP); Satoshi Ogata, Tokyo (JP); Kazutoshi Yoshimura, Tokyo (JP); Hitoshi Asano, Toyokawa-shi (JP); Hirotada Seki, Toyokawa-shi (JP); Akimasa Ishikawa, Toyokawa-shi (JP); Masashi Sugano, Tokyo (JP); Tsuyoshi Yoneyama, Tokyo (JP); Hiroyuki Maruyama, Toyokawa-shi (JP)

(21) Appl. No.: 17/020,220

(22) Filed: Sep. 14, 2020

(30) Foreign Application Priority Data
Sep. 12, 2019 (JP) 2019-165830

(51) Int. Cl. B65H 5/06; G03G 15/00; B65H 7/14

(52) U.S. Cl. CPC B65H 5/062; B65H 7/14; G03G 15/6529; G03G 15/5062

(57) ABSTRACT

Provided is a recording medium detection device which prevents a recording medium from jamming. The device comprises: a first roller and a second roller which nip and transport a recording medium; a roller shaft which rotatably supports the second roller; a shaft support; and a displacement detector. The shaft support supports the roller shaft movably in the thickness direction of the recording medium. The displacement detector detects displacement of the second roller in the thickness direction. The shaft support further supports the second roller movably in the transportation direction of the recording medium through the roller shaft.

### CROSS-REFERENCE TO RELATED APPLICATIONS

The present invention claims priority under 35 U.S.C. § 119 to Japanese Patent Application No. 2019-165829 and 2019-165830 filed on Sep. 12, 2019, the entire content of which is incorporated herein by reference.

### BACKGROUND

### Technological Field

The present invention relates to a recording medium detection device which detects the thickness and type of a recording medium and an image forming apparatus including the recording medium detection device.

### Description of the Related Art

An image forming system includes an image forming apparatus for forming an image on a recording medium such as a sheet of paper, and a recording medium supply device for supplying a recording medium to the image forming apparatus. The image forming apparatus forms an image on the recording medium according to output job information. The image forming apparatus includes a recording medium detection device which detects the size or type of the recording medium before an image is formed on the recording medium.

In the related art, for example, Patent Literature 1 (JP-A-2018-118811) describes this kind of recording medium detection device. Patent Literature 1 describes the technique that a paper thickness detection roller pair, which includes a first roller and a second roller to nip a recording medium, and a displacement sensor are provided and the paper thickness of the recording medium is detected according to the amount of displacement of the paper thickness detection roller pair which is driven to rotate on the recording medium.

### CITATION LIST

### Patent Literature

Patent Literature 1: JP-A-2018-118811

### SUMMARY

However, in the technique described in Patent Literature 1, the second roller is biased toward the first roller in order to form a nip part which nips the recording medium. Therefore, when the recording medium enters the nip part between the first roller and second roller, the first roller and second roller might put a load on the recording medium, thereby causing the recording medium to jam.

The present invention has been made in view of the above problem and has an object to provide a recording medium detection device and an image forming apparatus which can prevent the recording medium from jamming.

In order to solve the above problem and achieve the object of the present invention, according to an aspect of the present invention, a recording medium detection device reflecting one aspect of the present invention comprises: a first roller and a second roller which nip and transport a recording medium; a roller shaft which rotatably supports the second roller; a shaft support; and a displacement detector. The shaft support supports the second roller movably in the thickness direction of the recording medium through the roller shaft. The displacement detector detects displacement of the second roller in the thickness direction of the recording medium. The shaft support further supports the second roller movably in the transportation direction of the recording medium through the roller shaft.

According to another aspect of the present invention, an image forming apparatus reflecting one aspect of the present invention comprises: an image forming section which forms an image on a recording medium; and a recording medium detection device which is located more upstream than the image forming section in the transportation direction of the recording medium and detects the recording medium. As the recording medium detection device, the above recording medium detection device is used.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram which shows the general configuration of the image forming system according to an embodiment of the present invention;

FIG. 2 is a block diagram which shows the hardware configuration of the image forming system according to the embodiment of the present invention;

FIG. 3 is a schematic diagram which shows the structure of the recording medium detection device according to the embodiment of the present invention;

FIG. 4 is a perspective view which shows the first detecting section of the recording medium detection device according to the embodiment of the present invention;

FIG. 5 is a perspective view which shows the driven roller of the recording medium detection device according to the embodiment of the present invention;

FIG. 6 is an explanatory diagram which shows that the roller shaft is displaced in the transportation direction in the recording medium detection device in the related art;

FIG. 7 is an explanatory diagram which shows that the roller shaft is displaced in the transportation direction in the recording medium detection device according to the embodiment of the present invention;

FIG. 8 is an explanatory diagram which shows the positional relation among the driven roller, biasing member, and detection point in the recording medium detection device according to the embodiment of the present invention; and

FIG. 9 is an explanatory diagram which shows another example of the positional relation among the driven roller, biasing member, and detection point according to the embodiment of the present invention.

### DETAILED DESCRIPTION OF EMBODIMENTS

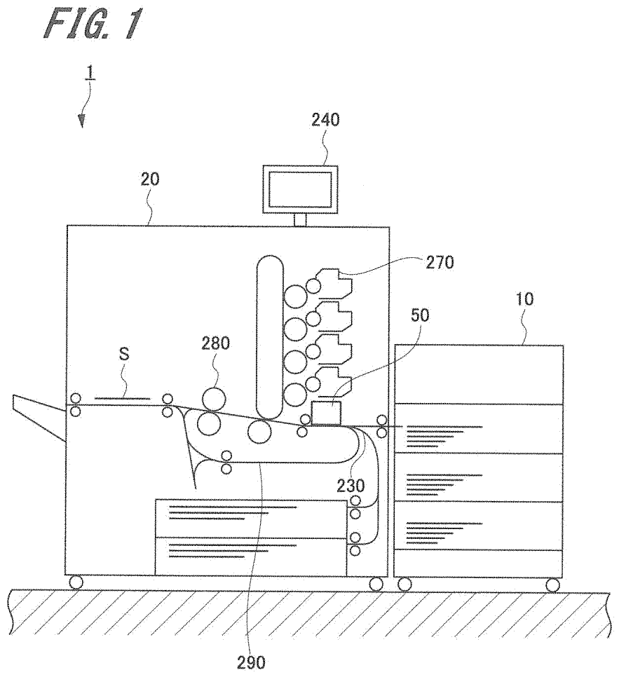

Hereinafter, an embodiment of the present invention will be described with reference to the drawings. A recording medium detection device and an image forming apparatus according to the embodiment of the present invention will be described with reference to FIGS. 1 to 9. In the figures, the same elements are designated by the same reference signs. The scope of the invention is not limited to the disclosed embodiment.

### 1. Embodiment of the Invention

### 1-1. Configuration of the Image Forming System

First, the general configuration of the image forming system according to an embodiment of the present invention (hereinafter called “the present embodiment”) is described below. FIG. 1 is a schematic configuration diagram of an image forming system 1 according to the present embodiment.

As shown in FIG. 1, the image forming system 1 includes a paper feed unit 10 for supplying a sheet of paper S as an example of a recording medium, and an image forming apparatus 20. The paper feed unit 10 and image forming apparatus 20 are each connected to a network such as a LAN and connected with each other via the network. In the image forming system 1, the paper feed unit 10 and image forming apparatus 20 are arranged side by side from the upstream side of the transportation path for the sheet S in the order of mention and connected in series.

The paper feed unit 10 is located on the most upstream side in the image forming system 1. The paper feed unit 10 includes a plurality of paper feed trays and can house a large volume of paper. The paper feed unit 10 supplies a sheet S housed in a paper feed tray to the image forming apparatus 20 by a paper conveyor.

Although the image forming system 1 which includes the paper feed unit 10 has been described above as an example, the image forming system 1 is not so limited and it may not include the paper feed unit 10.

The image forming apparatus 20 forms an image on the supplied sheet S according to output job information and image data. The image forming apparatus 20 forms an image on a sheet S, for example, by an electrophotographic method. The image forming apparatus 20 includes a paper conveyor 230, an operation display panel 240, an image forming section 270, a fixing section 280, and an inversion conveyor 290. The image forming apparatus 20 includes a sheet detection device 50 which detects the type, thickness, and so on of the sheet S.

The operation display panel 240, which serves as a warning section, is installed on the top of the chassis of the image forming apparatus 20. The operation display panel 240 is a display panel combined with a touch panel (operation section), which enables operation by the user and can display information.

The paper conveyor 230 transports the sheet S supplied from the paper feed unit 10 to the image forming section 270, fixing section 280, inversion conveyor 290 and a delivery tray.

The image forming section 270 includes image forming units for a plurality of colors (cyan, magenta, yellow, black, and so on) and can form a color toner image on a sheet. The fixing section 280, to which the sheet with a toner image formed thereon is transported, is located downstream of the image forming section 270 in the sheet transportation direction.

The fixing section 280 fixes the toner image transferred to the sheet S, on the sheet S by pressurizing and heating the transported sheet S. The sheet S subjected to the fixing process by the fixing section 280 is transported to the inversion conveyor 290 or paper delivery tray by the paper conveyor 230.

The inversion conveyor 290 includes an inversion section which inverts the sheet S. The sheet S inverted upside down or back and forth by the inversion section is made to pass through the inversion conveyor 290 and transported to the upstream side of the image forming section 270 or the downstream side of the fixing section 280.

The sheet detection device 50 is located more upstream than the image forming section 270 of the image forming apparatus 20 in the sheet transportation direction. However, the location of the sheet detection device 50 is not so limited; instead, the sheet detection device 50 may be located, for example, at the discharge side of the paper feed tray which houses the sheet S, in the image forming apparatus 20.

The sheet detection device 50, as an example of the recording medium detection device, transports the sheet S transported from the paper feed unit 10 or a paper feed tray and detects the physical property values of the sheet S during a sheet setting process. Then, the sheet detection device 50 sends the obtained detection information to the image forming apparatus 20.

The physical property values of the sheet S which are detected by the sheet detection device 50 are, for example, the basis weight, thickness, surface nature, sheet base, color, and so on of the sheet S.

### 1-2. Hardware Configurations of the Devices

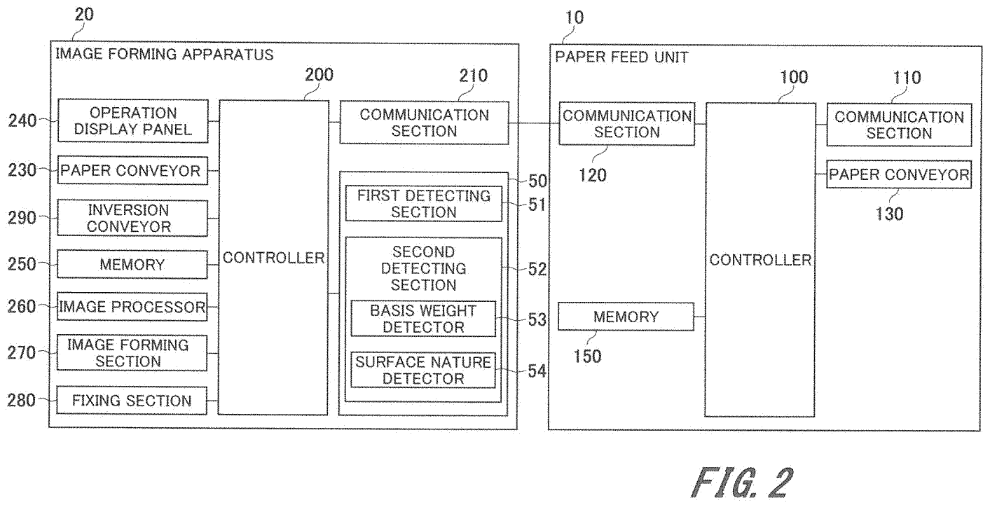

Next, the hardware configurations of the devices will be described referring to FIG. 2.

FIG. 2 is a block diagram which shows the hardware configurations of the devices of the image forming system 1.

First, the hardware configuration of the paper feed unit 10 is described below.

As shown in FIG. 2, the paper feed unit 10 includes a controller 100, communication sections 110 and 120, a paper conveyor 130, and a memory 150.

For example, the controller 100 has a CPU (Central Processing Unit). The controller 100 is connected to the communication sections 110 and 120, paper conveyor 130, and memory 150 through a system bus to control the entire paper feed unit 10.

The memory 150 is a volatile memory such as a RAM or a large-capacity nonvolatile memory. The memory 150 stores the program to be executed by the controller 100 and the like and is used as a working area for the controller 100.

The communication section 110 performs transmission and reception of data with an external device (client terminal, management device server or the like or mobile terminal) for the image forming system 1. The communication section 120 performs transmission and reception of data with the communication section 210 of the image forming apparatus 20.

Next, the hardware configuration of the image forming apparatus 20 will be described.

The image forming apparatus 20 includes a controller 200, a communication section 210, the paper conveyor 230, the operation display panel 240, a memory 250, an image processor 260, the image forming section 270, the fixing section 280, the inversion conveyor 290, and the sheet detection device 50.

The controller 200, which serves as a judgment section, has, for example, a CPU (Central Processing Unit). The controller 200 is connected to the communication section 210, paper conveyor 230, operation display panel 240, memory 250, image processor 260, image forming section 270, fixing section 280, and inversion conveyor 290 through a system bus to control the entire image forming apparatus 20. The controller 200 also controls the paper feed unit 10 and sheet detection device 50 through the communication section 210. In short, according to the present embodiment, the controller 200 controls the entire image forming system 1.

The memory 250, which serves as a storage, is a volatile memory such as a RAM or a large-capacity nonvolatile memory. The memory 250 stores the program to be executed by the controller 200 and the like and is used as a working area for the controller 200. The memory 250 also stores sheet setting information which indicates the size and type of the sheet S which is specified. The items to specify the sheet S are, for example, the base color, paper type, basis weight, and so on of the sheet S.

The image processor 260 acquires image data from the job information received from outside and performs image processing. The image processor 260 performs various types of image processing with the received image data, including shading correction, image density adjustment, and image compression, as necessary under the control by the controller 200. Then, the image data processed by the image processor 260 is sent to the image forming section 270. The image forming section 270 receives the image data subjected to image processing by the image processor 260 and forms an image on the sheet S according to the image data.

The operation display panel 240 is a touch panel which includes a display such as a liquid crystal display (LCD) or organic ELD (Electro Luminescence Display). The operation display panel 240 is an example of the input/output section which displays a command menu for the user, information on acquired image data, and so on. Furthermore, the operation display panel 240 includes a plurality of keys and receives various instructions and data as characters and numerals which are entered through key operation by the user, and sends an input signal to the controller 200.

The sheet detection device 50 includes a first detecting section 51 and a second detecting section 52. The first detecting section 51 transports the sheet S and detects the thickness of the sheet S. The second detecting section 52 includes a basis weight detector 53 for detecting the basis weight of the sheet S transported by the first detecting section 51 and a surface nature detector 54 for detecting the surface nature. The information detected by the sheet detection device 50 is sent to the controller 200.

### 2. An Example of the Structure of the Sheet Detection Device

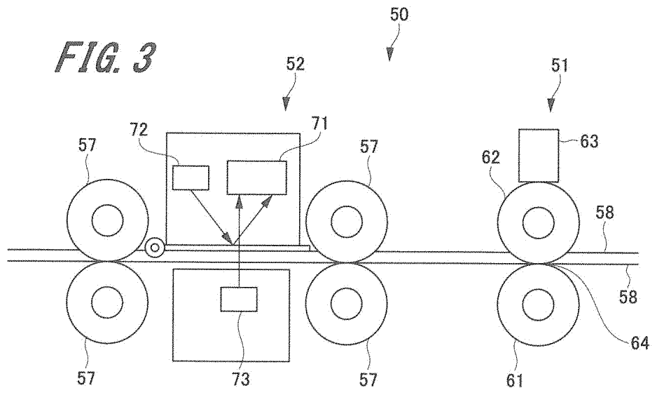

Next, the structure of the sheet detection device 50 will be described referring to FIGS. 3 to 5.

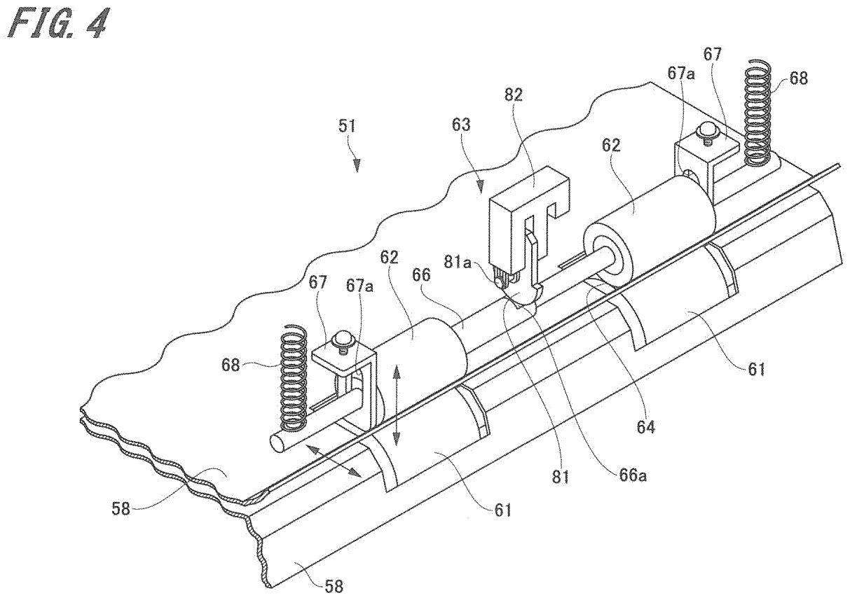

FIG. 3 is a schematic diagram which shows the sheet detection device 50. FIGS. 4 and 5 are perspective views which show the first detecting section 51.

As shown in FIG. 3, the sheet detection device 50 includes the first detecting section 51, the second detecting section 52, a plurality of conveyor rollers 57, and a pair of guide plates 58. The guide plates 58 face each other with a prescribed distance between them in the thickness direction which is perpendicular to the transportation direction of the sheet S and also perpendicular to the width direction of the sheet S.

The first detecting section 51 includes a drive roller 61 and a driven roller 62 which nip and transport the sheet, and a displacement detector 63. The drive roller 61, as the first roller, is rotated by a drive (not shown). The driven roller 62, as the second roller, is biased toward the drive roller 61 by a biasing member 68 which will be described later. The drive roller 61 and driven roller 62 come into contact with each other to form a nip part 64.

The first detecting section 51 detects the thickness of the sheet S from the displacement of the driven roller 62 in the thickness direction when the sheet S is inserted in the nip part 64 between the drive roller 61 and driven roller 62. The first detecting section 51 transports the sheet S downstream in the transportation direction using the drive roller 61 and driven roller 62. Details of the first detecting section 51 will be described later.

The second detecting section 52 is located more downstream than the first detecting section 51 in the transportation direction. The second detecting section 52 includes a light receiver 71, a first light emitter 72, and a second light emitter 73. The light receiver 71 and first light emitter 72 are located on one side in the thickness direction with the pair of guide plates 58 between them and the second light emitter 73 is located on the other side in the thickness direction. The first light emitter 72 and second light emitter 73 irradiate the sheet S with light. The light receiver 71 receives the light reflected by the sheet S and the light transmitted through the sheet S. The second detecting section 52 detects the basis weight and surface nature of the sheet S according to the signal of the light received by the light receiver 71.

As shown in FIGS. 4 and 5, the first detecting section 51 includes two drive rollers 61, two driven rollers 62, the displacement detector 63, a roller shaft 66, a shaft support 67, and the biasing member 68. The drive roller 61 and driven roller 62 face each other in the thickness direction of the sheet S. The two drive rollers 61 are spaced from each other in the width direction and similarly the two driven rollers 62 are spaced from each other in the width direction. The axial direction of the drive roller 61 and driven roller 62 is parallel to the width direction of the sheet S being transported. The driven roller 62 is rotatably supported by the cylindrical roller shaft 66.

The roller shaft 66 is movably supported by the shaft support 67 located on the guide plate 58. The rotation of the roller shaft 66 is restricted by a rotation restricting member (not shown). The shaft support 67 has a support hole 67a into which the roller shaft 66 is inserted. The support hole 67a is an oblong hole which extends by a given length along the thickness direction. The roller shaft 66 is supported slidably in the thickness direction along the support hole 67a of the shaft support 67.

The opening length of the support hole 67a in the transportation direction is longer than the diameter of the roller shaft 66. Therefore, a small clearance is generated between the roller shaft 66 and the support hole 67a in the transportation direction. The roller shaft 66 is supported by the shaft support 67 through the support hole 67a in a manner that it can move by a given length in the transportation direction.

The roller shaft 66 is biased toward the drive roller 61 by the biasing member 68. Therefore, the driven roller 62 supported by the roller shaft 66 is biased toward the drive roller 61. As the drive roller 61 rotates, the driven roller 62 also rotates together with the drive roller 61.

The biasing member 68 may be, for example, a compression coil spring. However, the biasing member 68 is not limited to a compression coil spring but it may be any of other various elastic members, such as a leaf spring or rubber.

The detection lever 81 of the displacement detector 63 abuts on the roller shaft 66. The displacement detector 63 includes the detection lever 81 abutting on the roller shaft 66, and a support part 82 for supporting the detection lever 81. The part of the detection lever 81 that abuts on the roller shaft 66 is virtually arc-shaped. The detection lever 81 is rotatably supported by the support part 82 through a rotation axis 81a. As the roller shaft 66 moves in the thickness direction, the detection lever 81 rotates around the support part 82. The displacement detector 63 detects the thickness of the sheet S from the rotation angle of the detection lever 81.

In the present embodiment, it is assumed that the thickness of the sheet S is detected from the rotation angle of the detection lever 81. However, the present invention is not so limited. Instead, the displacement detector 63 may use a measuring instrument or any other member that detects the displacement of the roller shaft 66 in the thickness direction.

Also, in the present embodiment, it is assumed that the roller shaft 66 is used as a displacement member and the detection lever 81 abuts on the roller shaft 66. However, the present invention is not so limited. Instead, an interlocking member whose position changes along with the roller shaft 66 in the transportation direction and thickness direction may be used as a displacement member. In that case, in the displacement detector 63, the detection lever 81 is made to abut on the interlocking member and the amount of displacement of the driven roller 62 in the thickness direction is detected from the amount of displacement of the interlocking member.

As mentioned above, the roller shaft 66 is supported by the shaft support 67 in a manner that it can move not only in the thickness direction but also in the transportation direction. Therefore, as the sheet S enters the nip part 64 between the drive roller 61 and driven roller 62, the driven roller 62 and the roller shaft 66 move in the transportation direction, following the sheet S. Consequently, the load which is generated when the sheet S enters the nip part 64 can be absorbed by the movement of the driven roller 62 in the transportation direction. This prevents paper jams in the nip part 64 between the drive roller 61 and driven roller 62.

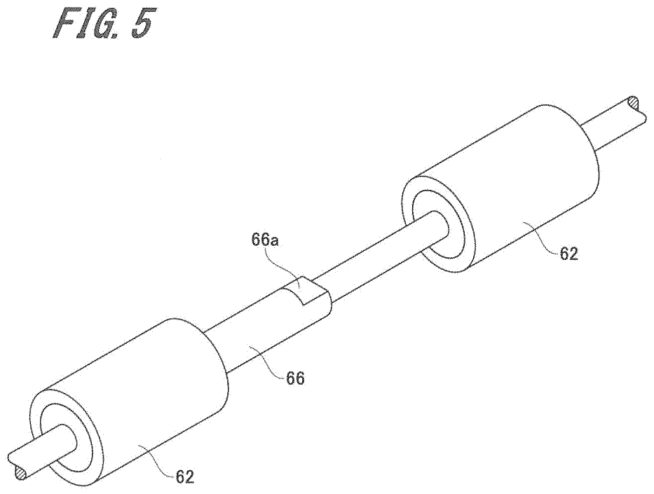

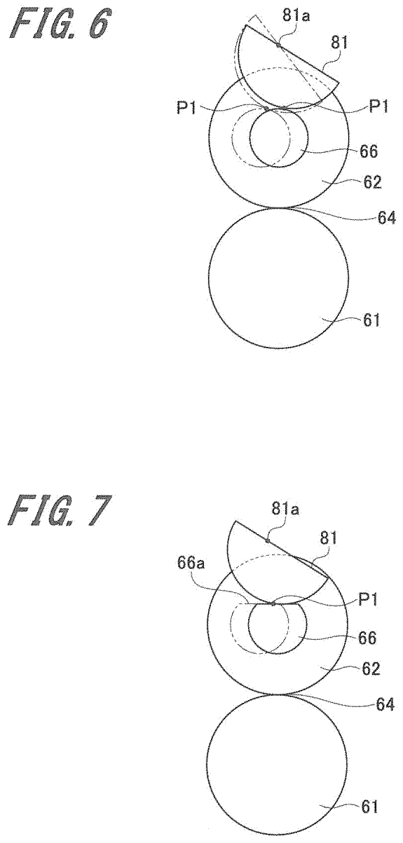

FIGS. 6 and 7 are explanatory diagrams which show that the roller shaft 66 is displaced along the transportation direction.

As shown in FIG. 6, as the roller shaft 66 moves in the transportation direction, the position of detection point P1 in the thickness direction, at which the roller shaft 66 comes into contact with the detection lever 81, changes because the roller shaft 66 has a cylindrical shape. As a result, the detection lever 81 would be rotated unintendedly, thereby causing a deterioration in the accuracy of thickness detection of the sheet S by the first detecting section 51.

For this reason, in the sheet detection device 50 according to the present embodiment, as shown in FIGS. 4 and 5, a flat part 66a is formed on the outer circumference of the roller shaft 66 at the position of contact with the detection lever 81. The flat part 66a is formed by making a flat notch in part of the outer circumference of the roller shaft 66. The flat part 66a is parallel to the transportation direction of the sheet S. Thus, the flat part 66a is perpendicular to the thickness direction.

In addition, the length of the flat part 66a in the transportation direction is longer than the clearance between the roller shaft 66 and the support hole 67a in the transportation direction. In other words, the length of the flat part 66a in the transportation direction is longer than the maximum length for which the roller shaft 66 can move in the transportation direction. Consequently, even if the roller shaft 66 moves in the transportation direction for the maximum length, the detection lever 81 stays on the flat part 66a. As shown in FIG. 7, even when the roller shaft 66 moves in the transportation direction, the position of detection point P1 in the thickness direction does not change and thus the detection lever 81 does not rotate. This improves the detection accuracy of the sheet detection device 50.

If an interlocking member which moves in conjunction with the roller shaft 66 is used as the displacement member, the flat part 66a is formed on the interlocking member.

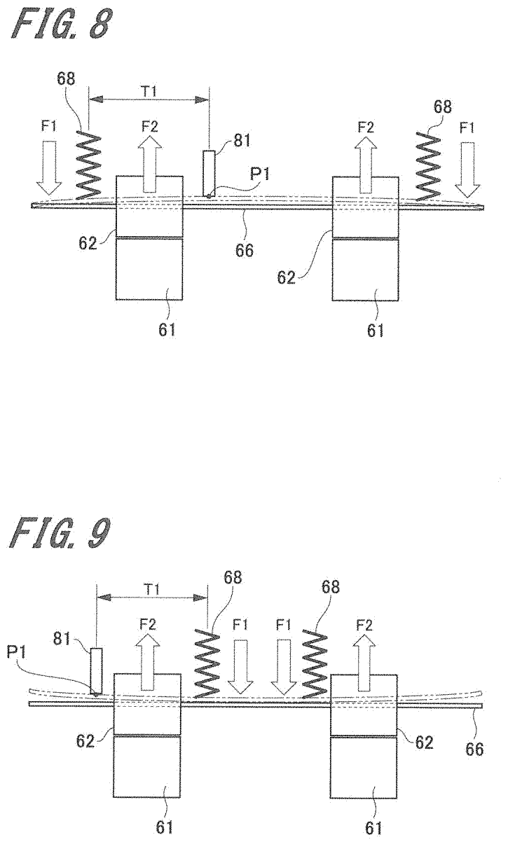

FIGS. 8 and 9 are explanatory diagrams which show the positional relation among the driven roller 62, biasing member 68, and detection point P1.

As shown in FIG. 8, a biasing force F1 toward the drive roller 61 is applied to the roller shaft 66 by the biasing member 68. When a relatively thick sheet S enters the nip part 64, a force F2 is applied in the direction of moving away from the drive roller 61 through the driven roller 62. If the biasing members 68 are installed on the roller shaft 66 outside the two driven rollers 62 in the axial direction, namely outside in the width direction, the center part between the two driven rollers 62 might largely sag or warp.

Therefore, it is preferable that the detection point P1 at which the detection lever 81 comes into contact with the roller shaft 66 be located opposite to the biasing member 68 with the driven roller 62 in between, namely inside the driven roller 62 in the axial direction, near the driven roller 62. Also, the detection point P1 should be located within a prescribed distance T1 from the biasing member 68 in the axial direction of the roller shaft 66 so that it is not affected by sagging or warping of the roller shaft 66.

As shown in FIG. 9, when the biasing member 68 is located inside the two driven rollers 62 in the axial direction, the detection point P1 is located outside one of the driven rollers 62 in the axial direction near the driven roller 62. Also in the example shown in FIG. 9, the detection point P1 should be located within the prescribed distance T1 from the biasing member 68 in the axial direction of the roller shaft 66 so that it is not affected by sagging or warping of the roller shaft 66.

When the prescribed distance T1 is shorter, the detection point P1 is less affected by sagging or warping of the roller shaft 66.

In the above first detecting section 51, the displacement detector 63 has one detection lever 81 and one detection point P1 is set on the roller shaft 66 as the displacement member. However, the present invention is not so limited. Instead, for example, a plurality of detection levers 81 may be provided to set a plurality of detection points P1 on the roller shaft 66 so that the displacement of the driven roller 62 in the thickness direction is detected from the average of detection values at the detection points P1.

So far, the embodiment and effects thereof have been described. However, the present invention is not limited to the above embodiment. The invention may be embodied in other various ways without departing from the gist of the invention as described in the appended claims.

Although in the above embodiment, four image forming units are used to form a color image, instead the image forming apparatus according to the present invention may use one image forming unit to form a monochrome image.

The display section which shows the result of detection by the sheet detection device 50 is not limited to the operation display panel 240. Instead, the display section of the external device (client terminal, management device server or the like or mobile terminal) which outputs job information to the image forming apparatus 20 may be used.

The above elements, functions, processing sections, and so on may be, in part or in whole, implemented by hardware such as an integrated circuit. The above elements, functions, and so on may be implemented by software through a processor which interprets and executes the program to perform the functions. The information to perform the functions, such as programs, tables and files, may be stored in a recording device such as a memory, hard disk or SSD (Solid State Drive) or a recording medium such as an IC card, SD card or DVD.

In the above example, it is assumed that a sheet of paper is used as the recording medium, but the invention is not so limited. Instead, a film, cloth or another type of material may be used as the recording medium.

In this specification, the terms “parallel” and “perpendicular” are used, but these terms do not mean “exactly parallel” and “exactly perpendicular”, respectively. The meanings of the terms herein include not only “parallel” and “perpendicular” but also “almost parallel” and “almost perpendicular” to the extent that the functions can be performed.

Although an embodiment of the present invention has been described and illustrated in detail, the disclosed embodiment is made for purposes of illustration and example only and not limitation. The scope of the present invention should be interpreted by terms of the appended claims.

### REFERENCE SIGNS LIST

1 . . . image forming system,
10 . . . paper feed unit,
20 . . . image forming apparatus,
50 . . . sheet detection device (recording medium detection device),
51 . . . first detecting section,
52 . . . second detecting section,
53 . . . basis weight detector,
54 . . . surface nature detector,
57 . . . conveyor roller,
58 . . . guide plate,
61 . . . drive roller (first roller),
62 . . . driven roller (second roller),
63 . . . displacement detector,
64 . . . nip part,
66 . . . roller shaft (displacement member),
66a . . . flat part,
67 . . . shaft support,
67a . . . support hole,
68 . . . biasing member,
71 . . . light receiver,
72 . . . first light emitter,
73 . . . second light emitter,
81 . . . detection lever,
82 . . . support part,
250 . . . memory (storage),
260 . . . image processor,
270 . . . image forming section,
290 . . . inversion conveyor,
P1 . . . detection point

What is claimed is:

1. A recording medium detection device comprising:
a first roller and a second roller which nip and transport a recording medium;
a roller shaft which rotatably supports the second roller;
a shaft support which supports the second roller movably in a thickness direction of the recording medium; and
a displacement detector which detects displacement of the second roller in the thickness direction of the recording medium, wherein
the shaft support further supports the second roller movably in a transportation direction of the recording medium through the roller shaft.

2. The recording medium detection device according to claim 1, further comprising:
a displacement member which moves in the thickness direction of the recording medium and the transportation direction together with the second roller, wherein
the displacement detector detects the displacement of the second roller from displacement of the displacement member in the thickness direction of the recording medium.

3. The recording medium detection device according to claim 2, wherein a flat part parallel to the transportation direction is formed at a position where the displacement detector detects the displacement of the displacement member.

4. The recording medium detection device according to claim 3, wherein the displacement detector includes a detection lever to come into contact with the flat part and a support part to rotatably support the detection lever and detects the displacement of the second roller from a rotation angle of the detection lever.

5. The recording medium detection device according to claim 3, wherein a length of the flat part in the transportation direction is larger than a range in which the roller shaft can move in the transportation direction.

6. The recording medium detection device according to claim 2, wherein the displacement member is the roller shaft.

7. The recording medium detection device according to claim 6, further comprising a rotation restricting member which restricts rotation of the roller shaft.

8. The recording medium detection device according to claim 6, further comprising a biasing member which biases the roller shaft toward the first roller, wherein
a detection point at which the displacement detector detects displacement of the roller shaft is located at a prescribed distance from the biasing member.

9. The recording medium detection device according to claim 8, wherein the detection point is located opposite to the biasing member with the second roller in between.

10. The recording medium detection device according to claim 1, wherein
the shaft support has a support hole in which the roller shaft is inserted,
the support hole is an oblong hole extending by a prescribed length in the thickness direction of the recording medium, and
an opening length of the support hole in the transportation direction is larger than a diameter of the roller shaft.

11. An image forming apparatus comprising:
an image forming section which forms an image on a recording medium; and
a recording medium detection device which is located more upstream than the image forming section in a transportation direction of the recording medium and detects the recording medium,
the recording medium detection device comprising:
a first roller and a second roller which nip and transport the recording medium;
a roller shaft which rotatably supports the second roller;
a shaft support which supports the second roller movably in a thickness direction of the recording medium through the roller shaft; and
a displacement detector which detects displacement of the second roller in the thickness direction of the recording medium, wherein
the shaft support further supports the second roller movably in the transportation direction of the recording medium through the roller shaft.
